(19) United States
(12) Patent Application Publication
(10) Pub. No.: US 2017/0124893 A1
(43) Pub. Date: May 4, 2017

(54) Multi Sensory Computer Aided - Common Quality Education for Everyone

(71) Applicant: Yesu S. Daasan, New Orleans, LA (US)

(72) Inventor: Yesu S. Daasan, New Orleans, LA (US)

(21) Appl. No.: 15/403,290

(22) Filed: Jan. 11, 2017

(51) Int. Cl. G09B 5/12; G09B 5/06

(52) U.S. Cl. CPC G09B 5/12; G09B 5/065

(57) ABSTRACT

The education system uses books and teachers. Students struggle to learn by reading and have trouble passing their exams. The methods of teaching and learning need to change. If every educational book is available as a video with every detail narrated as the teacher teaches in the classroom, this will help students to learn, especially those students who have difficulty learning from books. To facilitate learning each student will have available an in-home technical device and any electronic devices to access the information that they are studying. This will allow anyone to study any subject that they are interested in with their preferred method of study and at their own pace. For students from grammar school through higher education my program will make available to the parents access to what their child studies on a daily basis. My method will make a quality education accessible to each student.

### BACKGROUND OF MY INTELLECTUAL IDEA

Here I would like to explain the background of my intellectual idea of Multi Sensory Computer Aided—Common Quality Education for Everyone, how this idea came to my mind.

I was born in India. I studied and grew up in India. I am one of 11 children. I had a great desire to study and do research in science, but my family's financial situation made my dreams and my ambitions not come true and so, I become a technician. I am earring money through my job, but there is not any way my dreams or ambitions will come true. As a technician my job involves a lot of hard work, pain and sweat.

Growing up in India, I realized that so many young people have limited opportunities, because they have limited access to continuing education. Because, their financial situation and their ability to study. I came to understand that access to education including higher education is the secret to a successful and prosperous life.

I came to the United States on Dec. 30, 1998. I became a citizen of the United States in April, 2012. I have a 11-year-old son who was born in Tennessee and lives and goes to school in New Orleans, La. He is in the fifth grade in a public school. I am a single parent. My occupation is temporary construction worker. I want my son to have a better education than I had, so that his future possibilities are not limited as mine are and he does not need to go through all the pain that I go through everyday. I have a desire to send my son to a school where all the rich people's children go for him to have a better opportunity to learn different area of subjects and extra curriculam/activities like different subjects and modern technologies that what the rich people's children learn in the high priced private school. But, those private school's fees I cannot afford. When I came to that point, a question came to my mind that; why a child should have to have money to learn a subject and why a public school cannot provide that what private schools able provide for the rich people's children?

Living in the United States, I learned that not everyone is able to take advantage of the free education provided to them and quality education is not free in the America. Many of America's youth quit school, even before they finish high school, because the way of education is. As I thought about the problem, I saw that not everyone can work within the public and private educational structure and the way America's educational systems is designed.

When I was in India, at the age of ten I tried to learn more about science and to get to know about different areas of science. In addition, I was looking for books that explain in a simple way and in my language of Tamil. But I could not find books in Tamil that explained scientific principles in a simple way and I did not have time to go look for it, because I had to work. If I was not working, then I cannot go to school. Even when I had time there was no library near by where I was living in India. If I go to my school library, the librarian needed my teacher permission to issue a book and they will only give me the book that my teacher recommends. My teacher did not give permission, they tell me to study the class book first and make a better grade in your class book, then think about other books to study.

Even when I tried book stores, I did not know what book would cover what I was looking for. Even the store clerk could not help me or recommend a book or books that covered what I was looking for. I tried and I continued trying to get to know information regarding subjects that I was interested in, but I could not find the information I was seeking. I was hoping to find all the information in one place and easily accessible.

Even when I had time and when I found some simple books to read about different areas of information, when I read those books, I had to imagine what the book explained, but it was difficult for me to imagine and understand exactly about the book. Also, I did not have money to buy those books and keep them with me. I had to imagine and memorize what that book contained. Whenever I read books I felt that, if that book played as a video with someone explaining in the background that would be better and easier for understanding the book.

When I was 10 years old everyday after I finished all my work I went to sleep around 1 or 2 p.m. I had to sleep beside the road where I was working. In addition, everyday I had to get up early in the morning, around 5:00 or 5:30 a.m. Also before and after school I had to work. For me there was no after school free time, weekend play or summer school holidays, because I had to work every day. Every few months, I might have half a day to see my mother and my siblings. Everyday, after 8:00 or 9:00 p.m. and some times after 11:00 p.m., I would have a little time to do my homework and study.

I always had difficulty completing my homework and doing well in my courses. In addition, most of the time, I had a hard time catching up with all the information that my teachers taught in class, because I did not have the money or time for after school tutoring. Most of my friends attended after school tutoring. Most of these tutoring classes were run by the same teachers who taught the regular classes. So most of my friends had a better chance to finish their home work and do well in class.

Most of the time, I arrived late to school (a few minutes only). Two of my teachers beat me for being constantly late and told me that you cannot study; do not come back to school. These teachers said that I should quit school and do something else. I believed that their statement was not true about me and my knowledge. The truth was that I did not have the same opportunities that other students had because they had time to study and do homework. One day I was late again. Because I was late, two of my teachers beat me very hard with bamboo sticks. I had lots of bruises all over my body. My nose and my mouth were bleeding, I lost my balance and I fell down. One of the teachers said; “take your book bag and never come back to school again”. They thought I was not a serious student, but then they learned what was going on in my life. Both teachers took me to their office room. I was so scared, I started to cry and I was begging them not to hit me and that I had passed all of my classes. When they brought me inside of their office and closed the door I was too scared and I was crying very loud and I was telling them not to hit me. Both of the teachers hugged me. The teacher who kicked me cried and both of them said sorry to me. Also, they spoke to my family and helped me to come to school half an hour early and go home one hour late so that I could finish my homework at school and have time to play with other students. That was a new dawn in my life.

After I came to America and when I returned back to India from the United States, I went to see my old school, my class rooms, play ground and where the teachers beat me. I also visited the place where I slept on the side of the road and the places where I worked. Also, I saw one of the teachers who told me “take your book bag and never come back to school again”. He was old and he did not recognize me and I did not tell him who I was, because I was scared of him.

I started to work when I was 10 and still I am working. I realized when I was looking for a better job; I did not know how to find information about what are the different types of painless and better paying jobs that exist and what I needed to study to get a good job. When I went to find information from counselors, they could not help me at all.

When I came to America, in America also I found a big surprise and I realized that it does not matter, India or America, if someone has money, they and their children only can have a better education and a better quality of life. If someone has no money then they get nailed everyday to run their everyday lives, like what I am going through everyday in my life.

When I met different types of problems continuously to study a subject and to get a better job to have a better life then an Idea came in my mind as an intellectual to fix all the problems for anyone to study any subject and I feel that my Multi Sensory Computer Aided—Common Quality Education for Everyone, program will be able to reach every student, even those who have difficulty reading, learning and remembering information. My program will also encourage greater parental involvement with the learning process.

This is the background of how ! developed my intellectual idea of Multi Sensory Computer Aided—Common Quality Education for Everyone.

### BRIEF SUMMARY OF MY INTELLECTUAL IDEA

Here I would like to give a brief summary of my intellectual idea of Multi Sensory Computer Aided—Common Quality Education for Everyone.

Education is too hard for lots of people, because of the way of education is.

Lots of students even do not want to go to school or complete their high school. Because, these students do not want to or unable to read books or memorize them in the way our education system requires in order to pass their exams.

Our education system mostly uses books and uses teachers/professors as a tool to explain these books to students.

Not everyone likes to learn by reading. Many people have difficulty and struggle to learn by reading.

Not everybody able to read books. Learn from those books and to be a successful person in their life is not that easy for everyone.

Lots of students do not want to read books or have no interest to read books. Lots of them get sleepy when they read books or forgot what they read in the previous page.

When students see a big, big book in front of them, mentally they get tired, scared and panic because of the books size.

Many students have problem to read a book, memorize the information what is in the book and rewrite the information what they learned by book in the exam hall to pass their test.

Different students have different ways of learning. But our educational system treats every student in the same way. Not every student is able to learn in the way our educational system expects.

Many students have lake of concentration when professor teach in the class room.

When the professor teaches in the classroom if students fail to catch in that particular amount of time period then there is no way the professor will repeat the class again in the classroom.

Every teacher and professor is unique in the way they teach their students, students also are unique in the way they learn.

Students have to be in the class room at the particular time and they have to catch whatever the professor teaches them in that particular short time of period in the classroom. Most of them have a very hard time to concentrate or store everything in their mind in the short time of period.

Not everybody can learn at the same pace. Some students can learn in the classroom when a professor teaches, some students may need more explanations and want to hear more than once, some students may take longer than others.

Some students will learn in the morning, some of them learn better in the afternoon. Some of them learn better in the evening or some of them learn better in the night. But, our college schedule is not flexible for their interest or ability and our colleges treat every student in the same schedule which is difficult for most of them to do well.

When students take their college classes they never know or have any clue about their major, subjects or books.

Even if students have books in their hand still they do not know what their professor is going to teach that day, next day or everyday.

Many students and parents do not know what are the different types of jobs are available and they do not know what classes or majors need to take to get those jobs.

Most of the parents do not know about college or give career guidance to their child.

When a mother sends her child to school, she does not know what the teacher is going to teach her child in school and also she does not know what her child is going to learn from the teacher that day. Same as, when the child goes to school the child does not know what exactly the teacher is going to teach that day.

Not every child will lean in the same way or pace and each child is unique to learn.

Not everybody gets a high quality education. If someone has money then they can pay for their child to go to better schools and college to get a better education and job.

Not everybody has money to pay for their child to go to better schools or college.

Not all the schools have the same quality of education. How much money a person has and how much money they can spend will allow them to provide a higher quality education for their child. You should not need to be wealthy to have quality education.

Students should not need to go one place to another place, travel or migrate to another place where the school or college is located for better or higher education. All types of subjects and classes should be available to anyone able to study from any corner of the earth in their way, own pace and on their own schedules/in their comfortable time.

Every person on this earth has some special quality and ability and everyone has knowledge but to bring their knowledge out, the money, the language and the way of learning should not be the barrier.

The methods of teaching and the ways of learning need to change.

My intellectual idea of Multi Sensory Computer Aided—Common Quality Education for Everyone program will be able to reach every student, even those who have difficulty reading, learning and remembering information. My program will also encourage greater parental involvement with the learning process.

### DETAILED DESCRIPTION OF MY INTELLECTUAL IDEA PART—1 HARDSHIPS TO LEARN A SUBJECT

1. Inabilities become poverty, poverty becomes frustration and frustration becomes crime. Good education (Teaching/Learning in the right ways) can provide a person with self confidence, discipline and provide a high quality of life. These good characteristics can help a person to have a better quality of life. But, education is too hard for lots of people, because of the way of education is.

Education is suppose not just to read from what someone wrote on pieces of paper together in a book, memorize and rewrite them on a different piece of paper (which is called answer sheet) in the exam hall.

Lots of students even do not want to go to school or complete their high school. Because, these students do not want to or unable to read books or memorize them in the way of education system requires in order to pass their exams.

The education system mostly uses books and uses teachers/professors as a tool to explain these books to students.

Even though there is lots of projects, assignments, lab systems, practical and technical schools, still there is lack of a way to provide information efficiently to every student to learn. More over, still most of the lab, practical and technical schools based on to read books for student to do their projects, assignments, lab work or practical.

Not everybody able to read books. Learn from those books and to be a successful person in their life is not that easy for everyone.

Different students have different ways of learning. But educational systems treat every student in the same way. Not every student is able to learn in the way our educational system expects.

Some students can read, understand their books, and do well in their exams.

Some students learn by listening and reading books.

Some students want to see and learn.

Not everyone likes to learn by reading. Many people have difficulty and struggle to learn by reading. If someone needs to read a book to assemble something then it may be difficult for lots of people.

Those people who are able to read a book and memorize the important information from the book and are able to rewrite the important information in the exam hall, do assignments and/or do projects, they will find a better job, better income and a better life. In addition, they are called intelligent people. This is the way the educational system is now. But, every person on this earth has some special quality and ability.

People learn in different ways. Lots of people will learn better by seeing as visual and/or watch when others do.

When people watch what others do then they can do very simply, more quickly and better than what they saw from others.

Lots of students do not want to read books or have no interest to read books. Lots of them get sleepy when they read books or forgot what they read in the previous page.

When students see a big, big book in front of them, mentally they get tired, scared and panic because of the books size. Teachers or College professors do not use every single page of those books to prepare the students for their exams. Also, most of the teachers or professors do not read those whole books. More over, each of those books is so expensive.

If a student is young or adult it does not matter, but if they have difficulty to learn from a book then, both of their minds are same. To sign up for college is not going to change their ability to study (not for everybody). Also, they have to start everything from where they left off which is what they felt too hard for them when they were young and in anytime in their life. Because, they do not have an interest, ability or try to read book to learn, memorize them and rewrite them in the exam or do practical by what they read or learned from books.

It does not matter, the student continually studying or stop and then continuing, if there is no any change in their ability or in the way of the educational system then the student will struggle in the same way as in the beginning. They have to start to read book again from where they left off last time. Again, what the person hated the most which is to read, now student need to start to read from where the person left in the last time.

The education system is only suitable for those who can read from books, memorize them and rewrite them on a piece of paper in the exam hall. But, the education system is not suitable for people who do not have ability to read books, memorize them or rewrite them in the exam hall.

If it is very hard for this type of student to learn by reading when they were young or anytime in their life to learn by reading a book, and improve their education and life then, the way of educate needs to change.

2. Every teacher and professor is unique in the way they teach their students, even though they are well trained and follow the school/college curriculum and books. But, the way of teaching is different from one teacher to another because each one is unique. In addition, students also are unique in the way they learn, are able to concentrate in the classroom, memorize and are able to rewrite what they learned on their exam.

When the teacher or the professor explains things in the classroom, lots of student's eyes are looking at the teacher/professor or the board but their mind is somewhere else or they get sleepy in the classroom. It is very hard for most of them to concentrate or remember the things that the teacher or professor explained. When students leave the classroom most of them have not fully understood what they were taught that day from the professor.

Once, the professor explains things in the classroom and if student fails to catch in that particular amount of time period then there is no way the professor will repeat the class again in the classroom. Student may have questions, but the student will not get a chance to hear the class again. Now, the student is on their own. To read the book and understand about the chapter themselves or ask their friend is not that easy. Most of their friend's situations are the same thing.

3. Many students do not know what are the different types of jobs are available and they do not know what classes or majors they need to take to get those jobs.

Most of the parents do not know what the different types of jobs out there are and what their child needs to take In college to get a better job and to do well In their life. Also, parents do not know how to give career guidance to their child. Most of the parents do not know anything about college and how to give good guidance to their child.

From Pre-School to 12^{th} grade (High School) students follow what their school and their teachers instruct but after their high school most of the students do not know what they need to study and what major will help them to have a good job and to do well In their future.

When a student goes to speak with their advisors the advisors will recommend only what major is available in their college. In addition, the advisors will not give any advice or suggestions with what their college do not offer even though the student has different interests. They give yes or no answers only and give suggestions on what their college offers only.

Even most of the advisors do not know anything other than what their college preached to them to repeat over and over the same thing to the student.

Students believe that, particular major will help them to get a degree that they are interested in but when they started to take classes they find difficulties and many of them keep changing their major or stop going to college.

It does not matter, how many times the student changes their major still they are only changing their major within what majors are available in their nearest college or do some online degree. Already most of them have hard time learning from books, so these online courses are not comfortable for them either.

When students get interested to go (back) to college most of them do not know what is best for them to study and remain in their situation same as when they were in the beginning.

4. Lots of students do not know what they need to study to get a better job. In addition, when they start to live by themselves they do not have money or income enough to take care of them.

Most of the youth when they are young and single and when they stayed with their parents, they did not have any responsibility other than to go to school and study. But when they start to be responsible for themselves they face lots of challenges to run their everyday life.

Some of these youths have two or more jobs, but still not enough income to take care of their bills. Most of them do not have higher education.

When they decide to go back to school, they still have to work, if not they will not get pay or no money to pay for their bills and not enough time to study or enough money to pay for their school.

Even though the education loans pay for their classes, they have difficulty concentrating in their classes because they have lots of responsibility and not enough time or money to manage.

If they are not a full time student or a half time student, then the student is not eligible for student loans.

Even if they try to take one or two classes at a time the tuition fees are so high and the books are too expensive.

Some of the colleges and some of the professors want to use particular books only and those books will not be available anywhere else other than the particular college book store. In addition those books are so expensive.

Even if students pay for everything to take one or two classes, their class schedule and their work schedule will not provide a flexible situation. Some times they have to skip the semester or skip the shift. Either way they will be in trouble.

Even if the government takes care of the tuition and books still they have hard time to study. Because the education is too hard the way it is. Students have to be in the class room in the particular time and they have to catch whatever the professor teaches them in that particular short time of period in the classroom. Most of them have very hard time to concentrate or store everything in their mind in the short time of period.

Some students will learn in the morning, some of them learn better in the afternoon. Some of them learn better in the evening or some of them learn better in the night. But, the college schedule is not flexible for their interest or ability and the colleges treat every student in the same schedule which is difficult for most of them to do well.

When the students were young and had no any responsibility other then to go school and study they did not do well, but when they become an adult they have lots of responsibility but they want to study to get a better job.

Interest to go to college is not enough to give them knowledge or ability to study and the way of educational system is not that easy to let their dreams come true. If the education was easy then they may finish their college when they had time. Education is hard and they do not have ability to put effort to read books, to take exams and finish their college. That is why their life is difficult and they have a hard time to improving their life.

When they were young, they could not finish their college then it is even more difficult for them when they have more responsibility as an adult.

Even though, if the government gives them free money for their education, that money will not improve their mind or give them the ability to read books, concentrate in the class or study well.

5. Even if a student swims across all the difficulties and when they take their college classes they never know or have any clue about their major, subjects or books. When they go to their class and when their professor starts to give them study guide on the first day then the students come to know about their subject and about the books. But, even though the students have their schedule and their books in their hand still they do not know what their professor is going to teach that day, next day or everyday.

Not everybody can learn at the same pace. Some students can learn in the classroom when a professor teaches, some students may need more explanations and want to hear more than once, some students may take longer than others. But, making everyone at the same pace to learn is going to put some students unable to grasp the material and want to quit college.

Many of them take college classes but few of them only finish and get a degree. Out of those, few only get a Job at a trainee level.

After a student finishes their college and when the company hires them for a job there is an often big difference from what they learned in the college and in the real Job field.

What a student put all the effort and many scarifies to finish their college but when they get hired by a company they could not find the same thing that they learned 2, 3 or 4 years in the college. The 2, 3, or 4 years of college education are only for the basics and that piece of paper will show that they have finished their college. But, that is not enough for them to perform well or to be an experienced person in the work place. The college education may help some people that what they had learned from their college but not really. Work field are totally different from what they learned in the college.

6. When a mother sends her child to school she does not know what the teacher is going to teach her child in school and also she does not know what her child is going to learn from the teacher that day.

Same as, when the child goes to school the child does not know what exactly the teacher is going to teach that day. Also, the mother does not know what her child learned that day in school. Also, the mother does not know what her child is going to learn next day.

When the child in a classroom and when the teacher teaches not all the children pay attention in the same way, or understand in the same way from the teacher or learn from the teacher.

Every child is unique to learn and understand. In addition, each child has different pace of learning.

When teacher teaches in the class room not all the children learn at the same pace. Some children are quick to learn but some children need more time, even some children do not understand what it is going on.

Some children will learn by hearing when teacher is reading to them.

Some children will learn by hearing and watching models/toys/pictures.

Some children will learn better by watching a video.

7. When a mother gives birth, it does not matter if the mother is poor or rich; every mother wants to give a better education and better life to her child.

Many mothers do not want her child to go through what she went through in her life. But the way of educational system does not let her do as well as she has dreamed for herself or her child. She dose not have education, ability, knowledge or money to make changes to herself or to her generation. She remains in the same situation she was and this is continuing generation after generation.

Not everybody gets a high quality education. If someone has money then they can pay for their child to go to better schools and college to get a better education and job.

Not everybody has money to pay for their child to go to better schools or college.

Even though a poor mother has lots of desire in her heart to send her child to better schools, she cannot send her child to go to better school or college; because, those places are so expensive and a poor mother cannot even hope to send her child to good schools. Already a poor mother faces hard times for herself to survive with her child, and then it is too difficult for her to send her child to those types of better school.

Not all the schools have the same quality of education. How much money a person has and how much money they can spend will allow them to provide a higher quality of education for their child.

If someone is wealthy their child can have a better education and a better life, but if someone does not have money then their children cannot have the same quality of education that what the rich people's children get.

8. Students do not need to go one place to another place, travel or migrate to another place where the school or college is located for better or higher education. All types of subjects and classes should be available to anyone able to study from any corner of the earth in their own way, own pace and on their own schedules/in their comfortable time and language.

9. If a child is born in the United States and if the child's parents speak English only, but if the child goes to live with someone else who speaks a different language or if the child goes live somewhere else in the world then, the child will start to speak the language. If the parents go to live somewhere else then they also start to speak the local language. This ability to learn a new language demonstrates the ability to learn is more than enough to teach education to everyone.

10. Every person on this earth has some special quality and ability and everyone has knowledge but to bring their knowledge out, the money, the language and the way of learning should not be the barrier.

The methods of teaching and the way of learning need to change.

Please read my detailed description of my intellectual idea Part—2 Solution to learn a subject.

### PART 2 SOLUTION TO LEARN A SUBJECT

1. When someone writes a book (for education or any type of book) if each book is available online and if every single person is able to access those books online then they have no need to pay high prices for their books.

More over, if every type of book that is published and sold in this world for jobs, professions, education or research, if everything is available as a readable version, a narrated version and a video version, then, this will help every type of person to read and understand a book. The narrated version should play like someone reading to listeners with expression. The video version should have a video and someone narrating just as the narrated version has.

Especially if every single educational book (from preschool to the highest level of education in the world) is available as a detailed video with every single detail narrated very clearly as everyday the teacher/professor teaches in the class room, this will help so many more students to understand/learn from the books, especially those students who do not have any interest (or are unable) to read a book or learn from book.

If, all types of books is available as a detailed with every single step being narrated as what and how to do in that video, with lots of details and explanations stated very clearly, then these narrated videos will help almost anyone to have interest and be able (to read a book) to learn. People who have a difficult time learning from books, if they watch these narrated videos over and over then they will have a much better chance of understanding and learning the material.

People who do not have an interest in reading book and who have a difficult time to read or learn by reading a book, if they see and hear a book as a video with narration and if they can access these videos and be tested on what they have learned using any type of TV, computer or hand held device from any corner of this earth in their own language, this will help so many people throughout the world to improve their knowledge. They will start to read a book and it will help them to understand about the books/education in a better way.

Once the student watches the book as a video and hears the voice of expression and explanation by a talented narrator, then when the student reads that book then they can/will understand better and they will have interest to read books to learn.

Especially, after they have watched the video, if the student can perform exactly what they watched in that video and also if they perform well on a test/quiz of the material they saw in the video then a lot of them have a better chance of improving their skills. Also they will succeed in graduating from college; they will also have skills and get a better job.

Now the world gets its information only from people who can read, explain and remember what someone wrote in a book. They think they are the most intelligent. If education makes a way for everyone to learn easily, then the world will have more educated people, more new and better discoveries from different types of people.

If every day the education program tells the students what to do by class schedule and if the students print out the pages only what they are going to cover that day or the next day in their classroom instead of buying a whole book. This will help students not to get overwhelmed by big books. This will help them not to get stressed out by those big books or pay high price for those books. Also, this will help to reduce cut down trees.

If people are in school or not, if they can take a look at the books as video, listen to the narration or read from online, then more people will use those books. This will help the publisher and the author not to loose their money.

2. The main reason for student's lack of concentration in the class room is the method the education system still use to teach. Students should not need to wait to learn their subjects until the professor starts to teach in the classroom. Even before students sign up for class students should be able to see, learn and practice their subjects, lessons, homework, practice-work, lab work day by day until the entire major ends by video same as professor teaches everyday in the classroom.

If every major, subject, class and lab work is available to view as a video with narration from the first day to the end of the class/major. If these video options have rewind, fast-forward, and play back, then the students can play the videos again and again until they understand and have mastered the material. So, they can have a good knowledge of their major/subject even before they have signed up for their class.

So, student after signing up for the class and when the student is in the classroom, the student will know what the professor is going to teach today and tomorrow. So when the professor teaches the student will get better knowledge of that subject and be able to clarify their doubts with the professor in the classroom. Even after the professor teaches/end of the class, if student still has doubts they can go back and watch the video again and again until they understand. So, the video should play exactly what the professor teaches in the class room everyday. Also if the student wants to go deep into that subject to learn more, links and options should be available and students able to access those links/ options to go deep into that subject.

People have knowledge but some people have a problem to learn by book. The above method will help them to learn. Also to watch a video/learn by video will help people to understand better and develop their knowledge more efficiently and easily.

3. If there is an app to play videos randomly about different types/levels of jobs most/common/least availabilities and what majors, classes or training people need to take to get that jobs and approximate pay scale and college courses. This will help people to get to know more about the jobs, the availabilities and about what major and classes or training they need to take to get that job.

If people watch videos about jobs, the job video should Inform about the job and also should describe how the job is related to these classes and what they need to learn in the classes to do that job.

If people watch videos about classes then the class video should explain how the student is going to use these classes in the real job field.

When people see all these videos, it will motivate them to get to know more about those lobs for better income and a more comfortable life.

If people are interested in taking a look at information about their suitable job, the apps should take them to that particular job's detail videos and to the major/course detail videos that would inform them what they need to take to get that job. Also, the app should take them to the class videos. (The class video should be the same exactly what professors teach everyday in the college/classroom).

As I said earlier, people do not need to wait until they sign up for college or for the professor to teach in the classroom. Even before a student signs up for a class, they should be able to see the subjects, classes, lessons, homework, and practice-work day by day and until the major/class/training ends.

Even before people sign up for their college or training, if people able to watch their classes and their class's books/practical as a video same as how the professors are teaching in the college/classroom that will help them to get to know more about the classes, it will motivate them to sign up for the classes and they can do well in their classes.

4. If students do not have interest, involvement, concentration or not enough time to study, then whatever they study will not store in their mind. If a student cannot store information in their mind then they cannot retrieve anything in the exam hall. That is why students who are not capable to learn by book keep failing in school. That is why often they do not/could not graduate from high school.

Even though the intelligent student who is capable to read books, memorize and rewrite them in the exam hall, if they do not keep up with their work then they also will forget what they studied. But anyone who watches anything as a video and can repeat the video what they watched will stay in their memory for a long time.

If anything available as video then, peoples will show interests to watch more than to read.

If all the educational books are available as video same as teacher/professor teaches everyday in the classroom, if a person can able to view/watch their class/major subject as a video even before they sign up for their college, and if these video is available to play in any home T.V, computer or any hand held device with play back, rewind and pause, then, this will help lots of student to improve their knowledge to graduate and they will have better life.

Through apps if people can get information about jobs availability and an easy way to learn and if education is comfortable for everyone to learn in their way, own pace, on their own schedules, own language and in their comfortable time that will help them to do well in their college.

5. As I stated in my solution 2 and 4, if every major, subject, class and lab work is available to view as a video with narration from the first day to the end of the class/major. If these video options have rewind, fast-forward, and play back, then the students can play the videos again and again until they understand and have mastered the material. So, they can have a good knowledge of their major/subject even before they have signed up for their class.

When the student goes to college/technical school the college/technical school's classes must be matched to what the student is going to perform in their Job field. The companies and the education department should work together to make the college curriculum the way to conform to how the employers want the students/staff/workers to perform in their company.

While the students are in the college/technical schools they should have a chance to do their assignments/practical/job trainings with companies. So, when the student finishes their college/technical school there is not much difference than what they studied/learned and what they are going to perform in the job field.

The employer also will get a good employee. Also, the student will perform well when they get a job, because they have studied and trained with those companies. Students not only learn from college, the student should have the opportunity to know all the classes and the jobs even before they sign up for college by watching the video. What someone does after 4 years of college that the same job someone can/will do sooner and better by seeing and doing in a practical way/by as a video.

Hire the top teachers/professors in each field to develop a curriculum for schools and colleges, seek help from all the Intelligent people who work for the education, with the best psychologists and with the best IT animation/video creators. With all these talented people together make one good common curriculum by classes for every student and save those curriculums in a special server.

Every school, college, every teacher and every professor should use a projector in the class room and they should able to connect the projector to the special server to play the subject as a video to the children/students with narration as teacher/professor teaches in the classroom. The teacher/professor should able to pause, rewind, fast-forward, replay the video and explain the subject to the students which will help every student to get the same excellent education that someone gets from the high priced school.

These videos should be available to play on the any home television, computer and any type of electronic band held device. So, wherever and whenever the student wants to watch and learn that day's class material they are able to watch and learn.

Even If the mother is not educated, she can play the video and she can let her child to watch the video to learn as well as the mother also can learn with her child. No need to be wealthy to have a high quality education. Every child will have the same opportunity and the same quality of education from wherever they are.

Also, the mother can learn from the first day. The mother will know what her child is going to learn that day In school and what the teacher is going to teach to her child that day in school.

This video should play as a day by day calendar. Also, the mother should be able to see the entire school year or semester subject or classes, so she can prepare her child in advance or by day.

This type of program should nave assignments, quizzes and homework for the child to do.

Everyday mother/teacher should printout what the programs tell them to printout for the child to learn by day and to complete the daily homework. Also do the assignments that the program tells them to do and to prepare for testing the next or following days. So, the children carry only one electronic device, some paper, pencil, crayons and pens to school. So, the children no need to carry too many books in a big book sack. The same method should follow for the college professors and students.

Coloring, art, alphabet, numbering, addition, subtraction, different math, science and every subject should be there with interesting animation and with fun learning games to further educate the children.

Most of the children learn in a better way by visually seeing, and hearing at the same time like a watching a video.

Once the children watch the video and hear the audio at the same time like a video game then they start to pay attention and they can learn more easily. Also after they understand by watching a video then if someone reads to them or explained to them that what they watched as a video that will help them to understand better. Also, that will help them to have interest to learn and read.

Not only children, but adults also learn more easily and quicker by visually seeing and hearing at the same time as in a video.

7. If someone wants to have better education then they do not need pay high price or go to a particular school or college.

No students need spend so much money for education. Every student should get same quality of education.

The quality of education available to a child is not supposed to be dependant on the wealth of the child's parents. Education is not supposed to be a business. Learning environments such as school buildings and locations may differ for money but it should not matter if the school is public, private, or high priced, the qualify of education must be the same for everyone. It does not matter if someone has money or not, every single person must have the same quality of education. It does not matter where the student is and what environments the students is in to study. Even the student ready to study under any environments the same qualify of education must be available there that what the rich people's children get.

The subjects or classes should not be different from according to how much money they have. Everyone should have the same quality of education. Math is math and science is science. The school or the learning place may be different but what the students learn that must be the same quality. Education must not be determined by how much money they have. In addition, education should not be a business and not only reading from books. Education must be easy for anyone and for everyone with the same quality.

As I described in my solution 7 every school, college, every teacher and every professor should use a projector in the class room and they should able to connect the projector to the special server and play the subject to the children/students. So, students will get the same excellent education that someone gets from the high priced school.

If students have money and want to learn their education in the nice environments with nice buildings and with weather conditioning they can pay for the environment. If the students do not have money to pay for these types of nice environment but they have an interest to learn then they should able to learn the same quality of education in any environment that they are in.

8. As I described in my solution 7 if every school, college, every teacher and every professor use a projector in the class room and if they able to connect the projector to the special server and play the subject to the children/students then students do not need to go one place to another place, travel or migrate to another place where the school or college is located for better or higher education.

Any student from any corner of the earth should be able to register and should be able to access and take classes from the place where they are in.

If students show their mastery of learning they should have an easy way to go to a place where they can do their field practical. But to do/learn their academics/theory they should stay where they are.

Foreign students do not need travel or migrate to different place or country for their education. They should be able to study what they would study if they travel to different place or country from wherever they are.

All educational videos should be available in most major languages in the world. So, many different nations' students, schools and/or universities will register and they also can learn.

From any part of the world if parents/students/schools/universities register and if they pay some fees, then they should be able to access all the available courses from the special server to get educated and trained well just as they would travel somewhere for their education.

If students can access their subjects/class/major as videos and be tested on what they have learned using any type of TV, computer or any hand held device from any corner of this earth in their own language, in their way, own pace and on their own schedules/in their comfortable time this will help them to do well in their college this will help so many people throughout the world to improve their knowledge.

In case in some parts of the world students/parents have no power to access their education device or to watch the educational videos, and then they should have external chargers to charge their device. Also, these types of external charger should have option with charged by any wall outlet or with hand crank.

In the same way if any teachers/professors do not have power to operate the projector/education device they should able to use battery power. Also, the battery should be able to be charged by any wall outlet or with someone pedaling a cycle type crank charger.

The internet should be available in all parts of the world for teachers and students to be able to connect to the special server. This will help anyone to learn anything from the any part of the world by T.V., computer or by their hand held device.

If, all these educational videos are available in most major languages in the world then most of the people can learn easily in their mother/well-known language.

9. Children have the ability to repeat exactly what others say like a parrot, even though they do not know what it is. They have a strong memory. In early childhood, what a child sees and bears then they will not forget easily for the rest of their life. So, we can use this technique in an efficient way to teach the children in their early childhood. While playing a child's song to a child, we can create rhythmic fun song and/or video to teach some science and math laws (i.e. Newton's, Kepler's, Rutherford's, Einstein's, algebra, trigonometry and such as . . . ) to play to the child. This will help the child to memorize the science and math in an easy way in their early age.

When a child starts to learn colors and shapes, we can create videos to introduce planetary systems, the periodic table, chemicals, elements, compounds, single cell, multi cell organisms, bugs, insects, zoology, botany and such as a video and like a video game. This will help the child to learn and get to know those in an easy way in their early childhood. This is not only for preschool or kindergarten. This should be available for preschool to all the way to the highest fields of study.

For an example, If a student wants to know about the sand, the video should show different types of sand, where that sand is available and how that sand farmed in that area and what are the uses of that sand. Different types of sand, available area and comparison should be available and should show on a map with video and with someone narrating in the background.

Also with subjects to study such as, mountains, rivers, forest, animals, birds, insects, reptiles, and such as . . . should be available as a video. People should be able to see the comparison, and the location on the map. Same way the planets, stars, moons, sun, size, distance and the entire particulars should be available as a video.

These are all available in some online/web/media but only small bits of video and people do not know what information exists and what they need to watch or look for to learn in depth for the subject. But If every subject is available as a video and if a student/people want to know about anything then the video should be able to take them from pre-school level to extreme master level in an easy way.

Same way math, science, physics, chemistry and manufacturing, surgery, medicine, processing, and everything should be available as a video. With this complete information, students/people should be able to do projects, give new ideas, or make new discoveries.

Not only school books or college books, every single book should be available in this video method. All the books should be available in the video format with narration, only narration and/or readable version. So, more people will read/hear the book.

This video should be available to all age groups and for all age levels. The content must be same but the way of video explains/teaches should be different for the different age groups.

All the videos and every part of education should be available for every age group and level of intelligence. This means these videos should be available to watch and learn for young children up to the most intelligent person. (Like easy, medium, highest level by setting selection for each subject to learn for each level of people).

When a child/student watches a video about/for their class, they should have some break and that break should be a short, fun quiz period about history and science, arts, chemistry, physics, math, biology, zoology, botany, geology, astrology, technology, electrical, electronics, energy, gardening, etc.

If a child/student answers the quiz then they should get some credit toward their classes. If a student wants to know more about what they are interested in then, they should be able to go deeper, all the way to the expert level. Also, the video should have pause, play back, rewind, fast-forward and book mark.

The Student should net get credit until they reach the quiz and take the quiz. The quiz points should give them bonus points so they can get a better final grade.

Also, this will help the students to learn everything and not only what the corporate companies want.

10. If parents/peoples know about all the jobs and what classes need to take.
If companies and educational institutions cooperate together to prepare students for a job.
If all the educational books and job details are available as video and if that information is available in an easy way for students/people to learn,
Even before students sign up for their college, if students know and able to access their subject at their own pace and in their own time from wherever they are,
Without any differences if the same quality of education is available for rich and poor (all) people, then all of this together will result in better educated population. Also, this will help people to have a better life.

If people have a good education, job and better life then, definitely the crime rate also will come down.

The educational system needs to change to an easier way to teach/provide information for everyone to study a subject and/or acquire a skill.

Changes we need for everyone to have the same quality of education and learning in an easy way to have a better life.

My intellectual idea of Multi Sensory Computer Aided—Common Quality Education for Everyone program will be able to reach every student, even those who have difficulty reading, learning and remembering information. My program will also encourage greater parental involvement with the learning process.

1. My claim for a patent is the multi-sensory approach to education from grammar school through higher education by allowing the student several types of access to information through the computer. The same information should be made available to read, to listen to a narrated version or to watch as a video, allowing the student to choose his/her preferred method of learning. To further facilitate learning each student will have available an in-home/public technical/electronic device and/or any handheld electronic to access the information that they have an interest in studying. This will allow anyone to study any subject that they are interested in with their preferred method/methods of study and at their own pace. For students from grammar school through higher education my program will make available to the parent/parents access to what their child is studying on a daily basis.
My method of education will help anyone to learn any subject from any corner of the earth and make education affordable for everyone. Money, language and/or method of learning will not be barriers to have a quality education.
My method also will help to anyone to have high quality education if someone wants to have better education then they will not need to pay a high price or go to a particular school or college. No student needs to spend so much money for education. Every student will get the same qualify of education. The quality of education available to a child is not supposed to be dependant on the wealth of the child's parents. It does not matter where the student is and what environments the students is in to study. Even the student ready to study under any environments the same quality of education will be available there.
My method will keep the subjects or classes without any differences from according to how much money they have. Everyone will have the same quality of education. Math is math and science is science. The school or the learning place may be different but what the students learns that will be the same quality.
My method will help students to access their subjects/class/major as videos and be tested on what they have learned using any type of computer, TV or any hand held device from any corner of this earth in their own language, in their own way, own pace and on their own schedules/in their comfortable time.
My method will help to the educational systems to change to an easier way to teach/provide information for everyone to study a subject and/or acquire a skill.
My method will make possible for everyone to have the same quality of education and learning in an easy way to have a better life.
One of my major goals of my multi sensory program is to allow each student to pursue his/her career goals and be prepared for and find a job that will provide a good quality of life.
A good education is of great benefit to the individual. It however must be emphasized beginning in high school that is time to start thinking about and preparing for the students future and career choice/choices.
My method will help students from the beginning of high school by including in the curriculum a yearly class on career choices. Students will learn about various different careers and obtaining the qualifications to get a job, all the different types of jobs that are available and what courses of study will prepare them for the type of career they wish to pursue. The student will be encouraged to pursue a career that they will enjoy and that will also allow them to have a good quality of life.
Good education and to have a good job will help anyone to have a better quality of life and that will bring more prosperity to everyone. This is the main idea of my program for which I am applying/claim for a patent.
